(19) United States
(12) Patent Application Publication
(10) Pub. No.: US 2012/0039417 A1
(43) Pub. Date: Feb. 16, 2012

(54) BAND PASS SAMPLING RECEIVER

(75) Inventors: Hyung Jung KIM, Daejeon (KR); Jin Up Kim, Daejeon (KR); Jae Hyung Kim, Daejeon (KR)

(73) Assignee: Electronics and Telecommunications Research Institute, Daejeon (KR)

(21) Appl. No.: 13/005,938

(22) Filed: Jan. 13, 2011

(30) Foreign Application Priority Data
Aug. 10, 2010 (KR) 10-2010-0076887

(51) Int. Cl. H04L 27/00

(52) U.S. Cl. 375/316

(57) ABSTRACT

Provided is a band pass sampling receiver which performs a sampling operation to a combined signal of RF signals of different frequency bands. The band pass sampling receiver performs the sampling operation by applying a sampling rate having a time lag to a combined signal of first and second RF signals of different frequency bands. And, by using a result of the sampling operation and first and second interpolant functions, the first and second RF signals are separated from each other. Herein, the first and second interpolant functions are determined based on the time lag, the sampling rate and frequency bands of the first and second RF signals.

According to the band pass sampling receiver according to the embodiment of the present invention, the band pass sampling receiver selects the one frequency band among the plurality of frequency bands including the RF signals respectively by reconstituting of the signal process unit.

### CROSS-REFERENCE TO RELATED APPLICATIONS

This U.S. non-provisional patent application claims priority under 35 U.S.C. §119 of Korean Patent Application No. 10-2010-0076887, filed on Aug. 10, 2010, the entire contents of which are hereby incorporated by reference.

### BACKGROUND OF THE INVENTION

The present invention disclosed herein relates to a radio frequency receiver, and more particularly, to a band pass sampling receiver.

A superheterodyne receiver converts a received radio wave to an intermediate frequency having a certain frequency. And, by amplifying the converted intermediate frequency, sufficient amplification degree and selectivity are obtained. By using the amplified intermediate frequency, a baseband signal is down-converted.

In the case of receiving a Radio Frequency (RF) signal which is an analog signal, for applying an existing sampling theory, the RF signal is sampled by using a Nyquist sampling rate which is a sampling rate larger than at least twice as much as a carrier frequency. The more the carrier frequency of the RF signal is increased, the more the sampling rate is increased. However, a bandwidth of the RF signal, where a signal wanted to be received exits, is just about 0.03% to about 2% of the carrier frequency of the RF signal. In the case that the carrier frequency of the RF signal is a high frequency, the receiver should sample the RF signal with a higher sampling rate. In this case, a quantity of the sampled data increases exponentially, and the receiver should perform a data process very inefficiently.

For overcoming this limitation, a band pass sampling is proposed. According to the band pass sampling, the RF signal may be sampled with a lower sampling rate than the Nyquist sampling rate of the RF signal. The band pass sampling is also called a harmonic sampling or a sub-sampling.

The sampling may be performed with a lower sampling rate than the Nyquist sampling rate using the band pass sampling. Accordingly, the data quantity generated while the RF signal is sampled is reduced. According to the band pass sampling, aliasing is intentionally generated by performing the sampling with a lower rate in comparison with the Nyquist sampling rate. The band pass sampling basically has a sampling rate depending on a bandwidth of data.

The band pass sampling is generally applied to a digital direct conversion or an RF direct conversion. If the band pass sampling is applied to the digital direct conversion, the sampling is performed right after the RF signal received by an antenna is amplified at a Low Noise Amplifier (LNA). Therefore, a low-priced and small-sized receiver may be implemented.

### SUMMARY OF THE INVENTION

The present invention provides a band pass sampling receiver which performs downward conversion, quantization, signal separation, signal detection and signal suppression by referencing a phase shift of first and second stream signals, sampling frequency and frequency bands of the RF signals.

Embodiments of the present invention provide band pass sampling receivers including a sampling process unit configured to generate first and second stream signals sampled by applying a sampling rate having a time lag to a combined signal of first and second RF signals of different frequency bands; and a signal process unit configured to perform an operation to a first interpolant function and the first stream signal and to a second interpolant function and the second stream signal, and separate the first and second RF signals by adding results of the two operations, wherein the first and second interpolant functions are determined based on the time lag, the sampling rate and frequency bands of the first and second RF signals.

In some embodiments, the signal process unit may detect one of the first and second RF signals.

In other embodiments, the signal process unit may eliminate the first or second RF signals.

In still other embodiments, the first and second interpolant functions may be determined based on a phase shift of the first and second stream signals generated according to the time lag.

In even other embodiments, the first and second interpolant functions may be determined based on carrier frequencies of the frequency bands of the first and second RF signals.

In yet other embodiments, the carrier frequency of the frequency band of the first RF signal corresponds to a multiple of the sampling rate and a first constant, and the carrier frequency of the frequency band of the second RF signal corresponds to a multiple of the sampling rate and a second constant, and the first and second interpolant functions may be determined based on the first and second constants.

In further embodiments, the detecting the first RF signal may detect the first RF signal down-converted to a base band.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a second-order band pass sampling receiver;

FIG. 2 is a graph illustrating a positive frequency spectrum in the case that the second-order band pass sampling receiver receives first and second signals;

FIG. 3 is a block diagram illustrating a second-order band pass sampling receiver which receives a plurality of RF signals;

FIG. 4 is a graph illustrating a positive frequency spectrum in the case that first to Rth signals are inputted to the second-order band pass sampling receiver of FIG. 3; and

FIG. 5 is a graph illustrating a positive frequency spectrum in the case that 4 RF signals are received by the second-order band pass sampling receiver of FIG. 3.

FIG. 6 is a table exemplarily showing the value of the complex constant |C_{k,x}|.

### DETAILED DESCRIPTION OF PREFERRED EMBODIMENTS

The following explanations are just exemplary as a matter of fact, and they are not to limit the scope of the technical concept of the present invention. It should be understood that the above-given general explanations and the following explanations are exemplary, and it should be considered that additional explanations of the present invention are provided. Reference symbols are shown at the preferred embodiments of the present invention in detail, and examples of them are shown at the accompanying drawings. In any of possible cases, same reference numerals refer to same or like elements.

The expression “at least one of A, B and C” is interpreted as meaning logic (A or B or C) not using exclusive logic OR. It should be understood that steps of a method may be performed in different orders unless the principle of the present invention is changed.

Hereinafter, it will be described about an exemplary embodiment of the present invention in conjunction with the accompanying drawings.

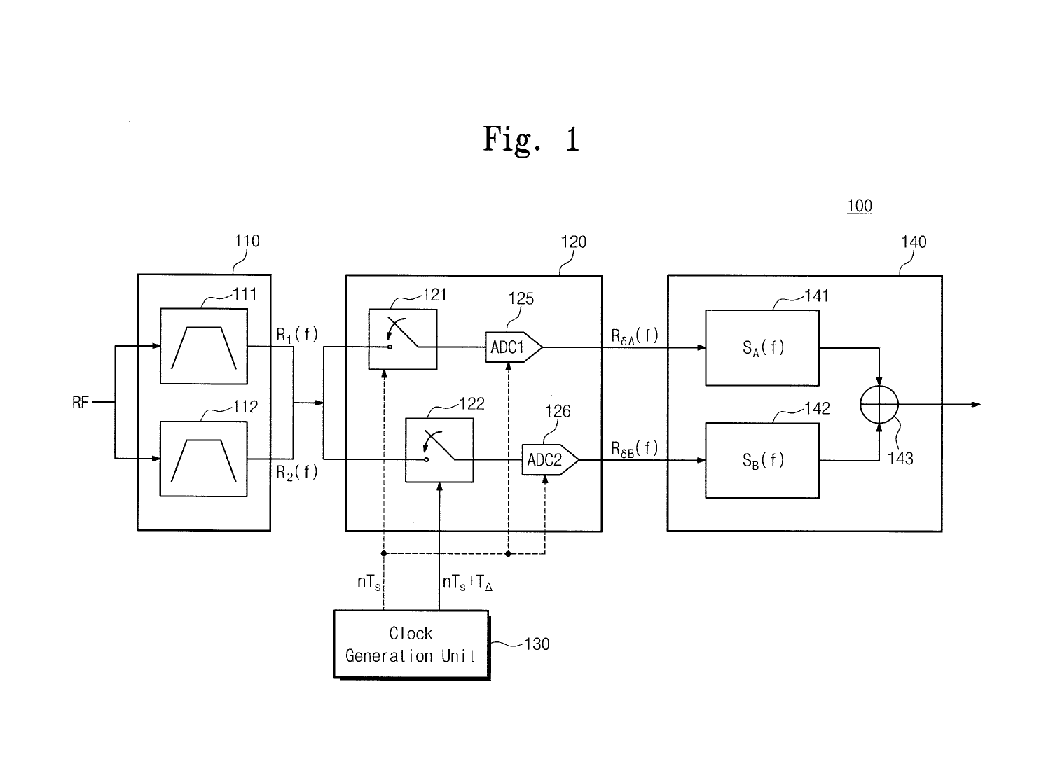

FIG. 1 is a block diagram illustrating a second-order band pass sampling receiver 100. Referring to FIG. 1, the second-order band pass sampling receiver 100 includes an RF filter unit 110, a sampling and quantization process unit 120, a clock generation unit 130 and a signal process unit 140.

The RF filter unit 110 selects an RF signal transmitted from a transmitter side (not shown). The RF filter unit 110 includes first and second RF filters 111 and 112. For instance, the first and second RF filters 111 and 112 may be tunable RF filters. The RF filter unit 110 selects a frequency band corresponding to first and second RF signals R₁(f) and R₂(f) by using the first and second RF filters 111 and 112. In FIG. 1, it is illustrated that the RF filter unit 110 selects two RF signals. However, this is just exemplary, i.e., the RF filter unit 110 may select a plurality of signals by using a plurality of RF filters.

The first signal R₁(f) is selected by the first filter 111. And, the second signal R₂(f) is selected by the second filter 112. Although not illustrated in FIG. 1, the second-order band pass sampling receiver 100 may include a Low Noise Amplifier (LNA). The first and second signals R₁(f) and R₂(f) may be amplified and transferred to the sampling and quantization process unit 120.

The sampling and quantization process unit 120 includes first and second sampling units 121 and 122, and first and second quantization units 125 and 126. The sampling and quantization process unit 120 converts an analog signal to a digital signal. That is, the sampling and quantization process unit 120 performs a sub-sampling operation to the first and second signals R₁(f) and R₂(f).

The first and second sampling units 121 and 122 perform the sampling operation to the selected signal in synchronization with a clock signal provided by the clock generation unit 130. The first sampling unit 121 performs the sampling operation to a signal which is a combined signal of the first and second signals R₁(f) and R₂(f) with nTₛ as a unit, where Tₛ is a sampling time. The second sampling unit 122 performs the sampling operation to the combined signal of the first and second signals R₁(f) and R₂(f) with nTₛ+TΔ as a unit. That is, the sampling operation of the second sampling unit 122 is delayed from that of the first sampling unit 121 as much as the delay time TΔ. Herein, n is an integer.

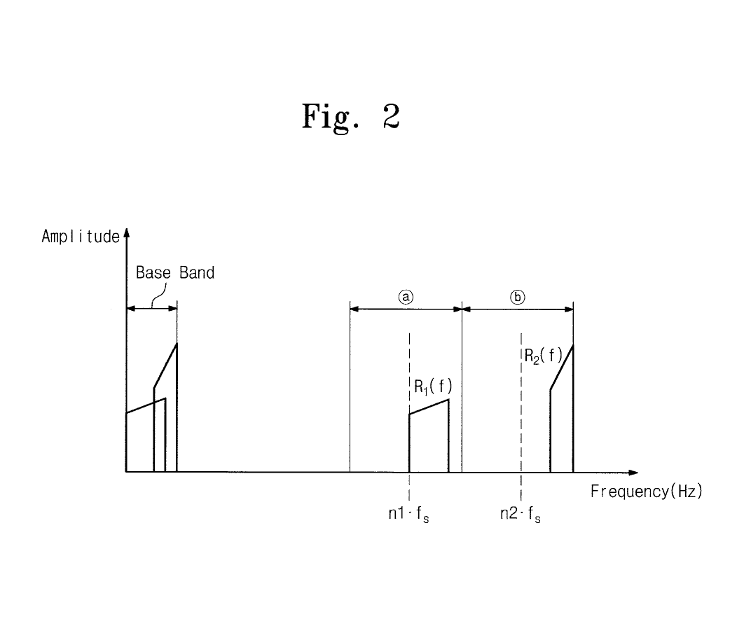

If the sampling operation is performed to the combined signal of the first and second signals R₁(f) and R₂(f), the aliasing is generated between the first and second signals down-converted to a baseband. For example, the baseband may be 1^{st} Nyquist zone. This will be explained in detail referring to FIG. 2.

The first and second quantization units 125 and 126 perform a quantization operation to signals sampled at the first and second sampling units 121 and 122 respectively. The first and second quantization units 125 and 126 perform the quantization operation based on the clock signal with nTₛ as a unit received from the clock generation unit 130.

And, the first and second quantization units 125 and 126 generate a first stream signal R_{δA}(f) and a second stream signal R_{δB}(f). That is, the processed and outputted signal from the first sampling unit 121 and the first quantization unit 125 is the first stream signal R_{δA}(f). The processed and outputted signal from the second sampling unit 122 and the second quantization unit 126 is the second stream signal R_{δB}(f).

The first quantization unit 125 transfers the first stream signal R_{δA}(f) to the signal process unit 140. The second stream signal R_{δB}(f) may be sampled after being delayed as much as TΔ in comparison with the first stream signal R_{δA}(f). In this case, there occurs a phase shift between the first and second stream signals R_{δA}(f) and R_{δB}(f).

The clock generation unit 130 generates the clock signal with nTₛ as a unit and the clock signal with nTₛ+TΔ as a unit. And, the generated clock signals are provided to the sampling and quantization unit 120.

The signal process unit 140 includes a first interpolant unit 141, a second interpolant unit 142 and an adder 143. The first interpolant unit 141 performs a multiplication operation to the first stream signal R_{δA}(f) and a first interpolant function S_{A}(f). The second interpolant unit 142 performs the multiplication operation to the second stream signal R_{δB}(f) and a second interpolant function S_{B}(f).

The adder 143 receives operation results of the first interpolant unit 141 and the second interpolant unit 142. And, the adder adds the operation result of the first interpolant unit 141 to that of second interpolant unit 142.

According to the band pass sampling receiver according to the embodiment of the present invention, the band pass sampling receiver selects the one frequency band among the plurality of frequency bands including the RF signals respectively by reconstituting of the signal process unit. That is, by performing a digital signal processing by using the phase shift of the first and second stream signals R_{δA}(f) and R_{δB}(f), only one of the first and second signal R₁(f) and R₂(f) may be recovered. Herein, the digital signal processing means a process of multiplying the first and second stream signals R_{δA}(f) and R_{δB}(f) by the first and second interpolant functions S_{A}(f) and S_{B}(f) respectively and adding the results of the multiplication.

FIG. 2 is a graph illustrating a positive frequency spectrum in the case that the second-order band pass sampling receiver 100 of FIG. 1 receives the first and second signals R₁(f) and R₂(f). Referring to FIG. 2, a horizontal axis represents a frequency, and a vertical axis represents amplitude of a signal. At a band divided by a predetermine frequency interval, the first and second signals R₁(f) and R₂(f) are positioned at first and second frequency bands \textcircled{a} and \textcircled{b} corresponding n1 and n2 respectively. Bandwidths of the first and second frequency bands \textcircled{a} and \textcircled{b} correspond to bandwidths of the first and second RF filters 111 and 112. And, the bandwidths of the first and second RF filters 111 and 112 are determined by the largest bandwidth among bandwidths of the first and second signals R₁(f) and R₂(f).

In FIG. 2, it is exemplarily illustrated that the first and second signals R₁(f) and R₂(f) are located at a bandwidth divided by an interval of a sampling rate fₛ. The sampling rate fₛ is 1/Tₛ (refer to the output of the clock generation unit 130 of FIG. 1). The sampling rate fₛ may be determined by the bandwidths of the first and second frequency bands \textcircled{a} and \textcircled{b}.

In FIG. 2, the RF signal R₁(f) represents RF signals received in first frequency band \textcircled{a}. For example, a transmitter can transmit a plurality of RF signals in one frequency band. In this case, the RF signal R₁(f) means the plurality of RF signals in one frequency band. Furthermore, the RF signal R₂(f) represents all RF signals received in second frequency band \textcircled{b}.

Signals of different frequency bands are transmitted and received based on the carrier frequency. For instance, the carrier frequency may be a center carrier frequency. The first signal R₁(f) included in the first frequency band \textcircled{a} is received based on a first carrier frequency n1·fₛ. The second signal R₂(f) included in the second frequency band \textcircled{b} is received based on a second carrier frequency n2·fₛ. n1 and n2 may be integers. Hereinafter, it is assumed that n1 and n2 are integers for convenience.

In the case that the first and second signals R₁(f) and R₂(f) are down-converted to the base band, there occurs the aliasing at the base band. According to the embodiment of the present invention, one of the first and second signals R₁(f) and R₂(f) down-converted to the base band may be selected, or both of them may be eliminated.

R_{δ1B}(f)=βⁿ¹·R_{δ1A}(f)

R_{δ2B}(f)=βⁿ²·R_{δ2A}(f) (1)

Equation (1) shows a relation between the first and second stream signals R_{δA}(f) and R_{δB}(f). In Equation (1), β=e^{-j2πTΔf}^{ₛ}, R_{δ1A}(f) corresponds to the first signal R₁(f) included in the first stream signal R_{δA}(f). R_{δ1B}(f) corresponds to the first signal R₁(f) included in the second stream signal R_{δB}(f). Likewise, R_{δ2A}(f) corresponds to the second signal R₂(f) included in the first stream signal R_{δA}(f). R_{δ2B}(f) corresponds to the second signal R₂(f) included in the second stream signal R_{δB}(f).

That is, the first stream signal R_{δA}(f) may include R_{δ1A}(f) which is a sub-sampled signal of the first signal R₁(f), and R_{δ2A}(f) which is a sub-sampled signal of the second signal R₂(f). The second stream signal R_{δB}(f) includes R_{δ1B}(f) which is a sub-sampled signal of the first signal R₁(f), and R_{δ2B}(f) which is a sub-sampled signal of the second signal R₂(f).

A relation between R_{δ1A}(f) and R_{δ1B}(f) depends on the delay time TΔ, the sampling rate fₛ and n1. A relation between R_{δ2A}(f) and R_{δ2B}(f) depends on the delay time TΔ, the sampling rate fₛ and n2.

Hereinafter, it is assumed that the first and second signals R₁(f) or R₂(f) are eliminated. The first and second interpolant functions S_{A}(f) and S_{B}(f) may be configured to satisfy Equations (2) and (3).

B·[S_{A}(f)·R_{+δ1A}(f)+S_{B}(f)·R_{+δ1B}(f)]=C·R_{+1A}(f−n1·B)

B·[S_{A}(f)·R_{-δ1A}(f)+S_{B}(f)·R_{-δ1B}(f)]=C·R_{-1A}(f+n1·B) (2)

B·[S_{A}(f)·R_{+δ2A}(f)+S_{B}(f)·R_{+δ2B}(f)]=0

B·[S_{A}(f)·R_{-δ2A}(f)+S_{B}(f)·R_{-δ2B}(f)]=0 (3)

In Equation (2), C is a complex constant. In Equations (2) and (3), B represents a larger bandwidth between the bandwidths of the first and second RF filters 111 and 112. C·R_{+1A}(f−n1·B) and C·R_{-1A}(f+n1·B) respectively represent a positive frequency spectrum and a negative frequency spectrum of the first signal down-converted to the base band.

R_{+δ1A}(f) and R_{-δ1A}(f) respectively represent the positive frequency spectrum and the negative frequency spectrum of R_{δ1A}(f). R_{+δ1B}(f) and R_{-δ1B}(f) respectively represent the positive frequency spectrum and the negative frequency spectrum of R_{δ1B}(f). Likewise, R_{+δ2A}(f) and R_{-δ2A}(f) respectively represent the positive frequency spectrum and the negative frequency spectrum of R_{δ2A}(f). R_{+δ2B}(f) and R_{-δ2B}(f) respectively represent the positive frequency spectrum and the negative frequency spectrum of R_{δ2B}(f).

In Equation (3), since the second signal R₂(f) is eliminated, the right side is 0. And, amplitude of the first signal (C·R_{+1A}(f−n1·B) and C·R_{-1A}(f+n1·B)) down-converted to the base band is proportional to the complex constant C.

For obtaining the first and second interpolant functions S_{A}(f) and S_{B}(f) which satisfy Equations (2) and (3), exemplarily, the first interpolant function S_{A}(f) may be selected as expressed in Equation (4) for convenience of computation.

$${S}_{A} ( f ) = \{ \begin{matrix}\frac{1}{B} & \vert f \vert < B \\ 0 & otherwise\end{matrix} \qquad ( 4 )$$

Meanwhile, referring to Equation (1), a relation of the first and second stream signals to the second signal R₂(f) (R_{δ2A}(f) and R_{δ2B}(f)) is expressed as Equation (5).

$$\{ \begin{matrix}{R}_{δ2 B} ( f ) = {β}^{- n 2} {R}_{δ2 A} ( f ) & f > 0 \\ {R}_{δ2 B} ( f ) = {β}^{n 2} {R}_{δ2 A} ( f ) & f < 0\end{matrix} \qquad ( 5 )$$

By substituting Equations (4) and (5) for Equation (3), Equation (6) is obtained.

$${S}_{B} ( f ) = \{ \begin{matrix}\frac{- {β}^{- n 2}}{B} & - B < f < 0 \\ \frac{- {β}^{n 2}}{B} & 0 < f < B\end{matrix} \qquad ( 6 )$$

Equation (6) represents a relation of the first and second interpolant functions S_{A}(f) and S_{B}(f). Since β=e^{-j2πTΔf}^{ₛ}, the relation of the first and second interpolant functions S_{A}(f) and S_{B}(f) may be determined by the delay time TΔ, the sampling rate fₛ and a value of n2.

Meanwhile, like Equation (1), a relation of the first and second stream signals to the first signal R₁(f) (R_{δ1A}(f) and R_{δ1B}(f)) is expressed as Equation (7).

$$\{ \begin{matrix}{R}_{δ1 B} ( f ) = {β}^{- n 1} {R}_{δ1 A} ( f ) & f > 0 \\ {R}_{δ1 B} ( f ) = {β}^{n 1} {R}_{δ1 A} ( f ) & f < 0\end{matrix} \qquad ( 7 )$$

By substituting Equations (6) and (7) for Equation (2), Equation (8) is obtained.

R_{+δ1A}(f)·[1−βⁿ²·β⁻ⁿ¹·R_{+δ1A}(f)]=C·R_{+1A}(f−n1·B)

R_{-δ1A}(f)·[1−β⁻ⁿ²·βⁿ¹·R_{-δ1A}(f)]=C·R_{-1A}(f+n1·B) (8)

In Equation (8), it is assumed that the sampling rate fₛ is a bandwidth B. And, it may be that β=e^{-j2πTΔf}^{ₛ}=e^{-j2πTΔB}.

The amplitude of the first signal down-converted to the base band is proportional to the complex constant C. According to the embodiment of the present invention, an absolute value of the complex constant C is determined based on the delay time TΔ, the sampling rate fₛ and the first and second frequency bands \textcircled{a} and \textcircled{b}. For instance, the absolute value of the complex constant C is calculated as expressed in Equation (9).

|C|=|1−β^{±(n2-n1)}|=\sqrt{2·(1−cos [2π·TΔ·fₛ·|n2−n1|])} (9)

Referring to Equation (9), the value of the complex constant C is determined based on the delay time TΔ, the sampling rate fₛ and |n2−n1|.

In the case of |C|=0, the amplitude of the first signal down-converted to the base band may be 0. In this case, the first and second signals down-converted to the base band may be eliminated. The case of |C|=0 is called an interpolant null.

In the case of |C|≠0, the amplitude of the first signal down-converted to the base band may have a certain value. In detail, in the case of 2π·TΔ·fₛ·|n2−n1|=2π·m, the amplitude of the first signal down-converted to the base band may be 0. And, in the case of 2π·TΔ·fₛ·|n2−n1|≠2π·m, the amplitude of the first signal down-converted to the base band may have a certain value. Herein, m is an integer.

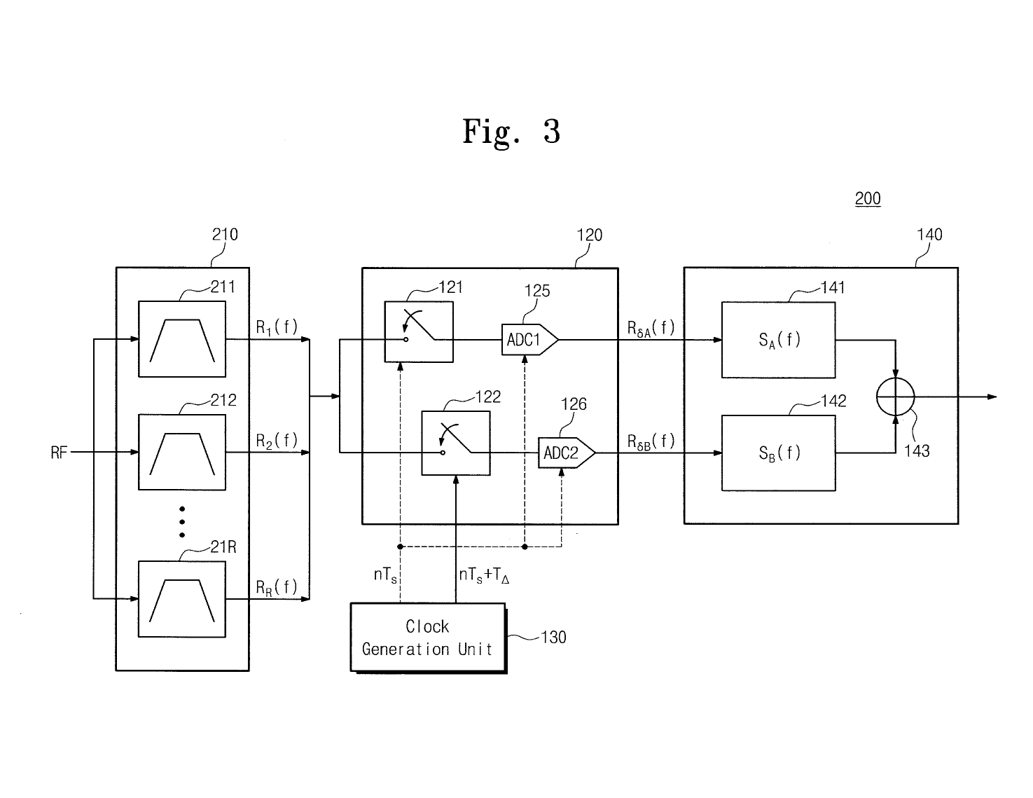

FIG. 3 is a block diagram illustrating a second-order band pass sampling receiver 200 which receives a plurality of RF signals. The second-order band pass sampling receiver 200 includes an RF filter unit 210, a sampling and quantization process unit 120, a clock generation unit 130 and a signal process unit 140. Referring to FIG. 3, the second-order band pass sampling receiver 200 is configured in the same manner as the second-order band pass sampling receiver 100 except that the RF filter 210 selects more than two frequency bands.

The RF filter unit 210 includes first to Rth RF filters 211 to 21R. The first to Rth RF filters 211 to 21R respectively select predetermined frequency bands and output first to Rth signals R₁(f) to R_{R}(f).

A signal generated by combining the first to Rth signals R₁(f) to R_{R}(f) is sequentially inputted to the first sampling unit 121 and the first quantization unit 125, and outputted as the first stream signal R_{δA}(f). And, the signal generated by combining the first to Rth signals R₁(f) to R_{R}(f) is sequentially inputted to the second sampling unit 122 and the second quantization unit 126, and outputted as the second stream signal R_{δB}(f).

The signal process unit 140 includes the first and second interpolant units 141 and 142, and the adder 143. According to the embodiment of the present invention, the first and second interpolant functions S_{A}(f) and S_{B}(f) are selected referring to the sampling rate fₛ, the delay time TΔ, and frequency bands of the first to Rth signals R₁(f) to R_{R}(f).

According to the embodiment of the present inventions, one RF signal is obtained among a plurality of RF signals by reconstructing of the signal process unit.

Furthermore, assume that some of the first to Rth signals R₁(f) to R_{R}(f) are interference signals, and not regular signals. By reconstructing of the signal process unit, the interference signals are eliminated, and signal in desired frequency band may be obtained.

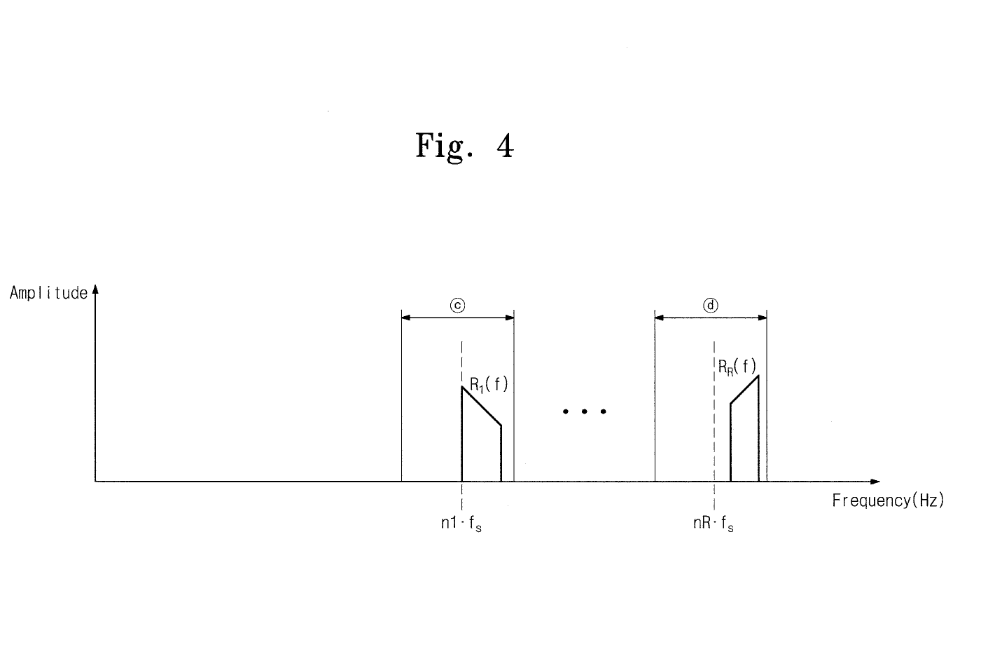

FIG. 4 is a graph illustrating a positive frequency spectrum in the case that the first to Rth signals R₁(f) to R_{R}(f) are inputted to the second-order band pass sampling receiver 200. Referring to FIG. 4, a horizontal axis represents a frequency, and a vertical axis represents amplitude of a signal. At a band divided by interval of the sampling rate fₛ, the first to Rth signals R₁(f) and R_{R}(f) are positioned at first to Rth frequency bands \textcircled{c} to \textcircled{d} corresponding n1 to nR respectively.

The signals included in the first to Rth frequency bands \textcircled{c} to \textcircled{d} are transmitted and received based on carrier frequencies n1·fₛ to nR·fₛ respectively. n1 to nR may be integers. Hereinafter, it is assumed that n1 to nR are integers for convenience.

As above-described referring to Equations (2) to (9), the signal process unit 140 performs the signal processing to the first stream signal R_{δA}(f) and the second stream signal R_{δB}(f), and may detect a signal of a desired frequency band. For instance, an output result of the adder 143 is expressed as Equation (10).

F=(S_{A}(f)·R_{δ1A}(f)+S_{B}(f)·R_{δ1B}(f)+ . . .

+S_{A}(f)·R_{δRA}(f)+S_{B}(f)·R_{δRB}(f) (10)

In Equation (10), F represents an output signal of the adder 143. Like Equation (1), the relation between the first and second stream signals R_{δA}(f) and R_{δB}(f) is expressed as Equation (11).

R_{δkB}(f)=β^{nk}·R_{δkA}(f) (11)

In Equation (11), 1≦k≦R, β=e^{-j2πTΔf}^{ₛ}. Equation (11) shows the relation between the first and second stream signals R_{δA}(f) and R_{δB}(f). That is, the relation between the first and second stream signals R_{δA}(f) and R_{δB}(f) of the kth signal Rₖ(f) may be determined according to the delay time TΔ, the sampling rate fₛ and nk. By substituting Equation (11) for Equation (10), Equation (12) is obtained.

$$\begin{matrix}F = {R}_{δ1 A} \cdot ( f - n 1 \cdot B ) \cdot ( {S}_{A} ( f ) + {S}_{B} ( f ) \cdot {β}^{n 1} ) + … + {R}_{δ RA} \cdot \\ ( f - nR \cdot B ) \cdot ( {S}_{A} ( f ) + {S}_{B} ( f ) \cdot {β}^{nR} ) \\ = {C}_{1 , x} \cdot {R}_{1 A} ( f - n 1 \cdot B ) + … + {C}_{k , x} \cdot {R}_{kA} ( f - nk \cdot B ) + \\ {C}_{R , x} \cdot {R}_{RA} ( f - nR \cdot B )\end{matrix} \qquad ( 12 )$$

The output signal of the adder 143 may be expressed as Equation (12) at the base band. C_{1,x}·R_{1A}(f−n1·B) to C_{R,x}·R_{RA}(f−nR·B) respectively represent the first to Rth signal down-converted to the base band. C_{k,x}·R_{kA}(f−nk·B) (1≦k≦R) represents the kth signal down-converted to the base band. Absolute values of C_{1,x}·R_{1A}(f−n1·B) to C_{R,x}·R_{RA}(f−nR·B) may be respectively proportional to those of the complex constants C_{1,x} to C_{R,x}.

That is, the absolute value of the kth signal down-converted to the base band may be proportional to the absolute value of the complex constant C_{k,x}. Accordingly, based on the absolute value of the complex constant C_{k,x}, the RF signals of different frequency bands may be recovered or eliminated.

The relation between the first interpolant function S_{A}(f) and the second interpolant function S_{B}(f) is exemplarily expressed as Equation (13).

$${S}_{B} ( f ) = \{ \begin{matrix}- {β}^{- nx} {S}_{A} ( f ) & - B < f < 0 \\ - {β}^{nx} {S}_{A} ( f ) & 0 < f < B\end{matrix} \qquad ( 13 )$$

In Equation (13), the relation between the first and second interpolant functions S_{A}(f) and S_{B}(f) may be determined according to the delay time TΔ, the sampling rate fₛ and a value of nx.

Referring to Equation (13), the absolute value of the complex constant C_{k,x} (1≦k≦R) of Equation (12) is expressed as Equation (14).

|C_{k,x}|=|1−β^{±(nk-nx)}|=\sqrt{2·(1−cos [2π·TΔ·fₛ·|nk−nx|])} (14)

Referring to Equation (14), the absolute value of the complex constant C_{k,x} is determined according to the delay time TΔ, the sampling rate fₛ, nk and nx. nk (1≦k≦R) may correspond to the carrier frequencies of the first to Rth frequency bands \textcircled{c} to \textcircled{d}.

According to the embodiment of the present invention, it is determined whether to recover a signal at the base band according to the absolute value of the complex constant C_{k,x}. In the case of |C_{k,x}|=0, the absolute value of the kth signal down-converted to the base band may be 0. And, in the case of |C_{k,x}|≠0, the absolute value of the kth signal down-converted to the base band may have another value but 0.

In detail, in the case of 2π·TΔ·fₛ·|nk−nx|=2π·m, the absolute value of the kth signal down-converted to the base band may be 0. And, in the case of 2π·TΔ·fₛ·|nk−nx|≠2π·m, the absolute value of the kth signal down-converted to the base band may have a certain value. Herein, m is an integer.

According to Equation (14), in the case that the RF signals of different frequency bands are received, an undesired signal may be eliminated by using the delay time TΔ, the sampling rate fₛ, and |nk−nx|.

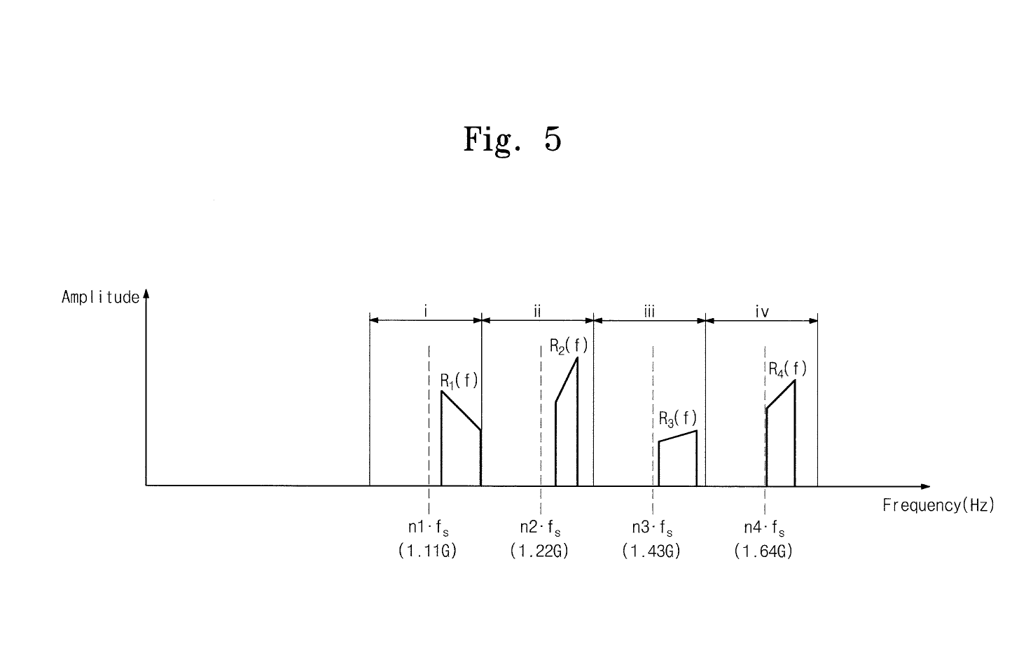

FIG. 5 is a graph illustrating a positive frequency spectrum in the case that 4 RF signals are received by the second-order band pass sampling receiver 200 of FIG. 3. Referring to FIGS. 3 and 5, the RF signals of 4 frequency bands are received by the second-order band pass sampling receiver 200. The different 4 RF signals R₁(f) to R₄(f) are respectively positioned at different frequency bands n1, n2, n3 and n4 divided by interval of the sampling rate fₛ.

In FIG. 5, the first to fourth RF signals R₁(f) to R₄(f) represents RF signals received in first to fourth frequency bands i to iv respectively. For example, a transmitter can transmit a plurality of RF signals in one frequency band. In this case, the RF signal R₁(f) may represent the plurality of RF signals in one frequency band.

The RF filter unit 210 may select the first to fourth RF signals R₁(f) to R₄(f). For instance, the RF filter unit 210 may include 4 RF filters, and select the first to fourth RF signals R₁(f) to R₄(f) through a band pass filtering process.

The sampling and quantization unit 120 may perform the sampling and quantization operation to the first to fourth RF signals R₁(f) to R₄(f). The sampling and quantization unit 120 may perform the sampling and quantization operation in synchronization with the clock signal of the clock generation unit 130. The sampling and quantization unit 120 may generate the first and second stream signals R_{A}(f) and R_{B}(f).

The signal process unit 140 receives the first and second stream signals R_{A}(f) and R_{B}(f). The signal outputted from the adder 143 is expressed as Equation (15) at the base band.

$$\begin{matrix}F = {R}_{δ1 A} \cdot ( f - n 1 \cdot B ) \cdot ( {S}_{A} ( f ) + {S}_{B} ( f ) \cdot {β}^{n 1} ) + … + {R}_{δ4 A} \cdot \\ ( f - n 4 \cdot B ) \cdot ( {S}_{A} ( f ) + {S}_{B} ( f ) \cdot {β}^{n 4} ) \\ = {C}_{1 , x} \cdot {R}_{1 A} ( f - n 1 \cdot B ) + … + {C}_{4 , x} \cdot {R}_{4 A} ( f - n 4 \cdot B )\end{matrix} \qquad ( 15 )$$

Referring to FIG. 5 again, first to fourth frequency bands i to iv respectively correspond to n1·fₛ to n4·fₛ.

For instance, it is assumed that carrier frequencies of the first to fourth frequency bands i to iv are respectively about 1.11 GHz, about 1.22 GHz, about 1.43 GHz and about 1.64 GHz. And, it is assumed that only the signal of 1.11 GHz is to be recovered. According to absolute values of the complex constants C_{1,x} to C_{4,x}, it is determined whether to recover the signal at the base band.

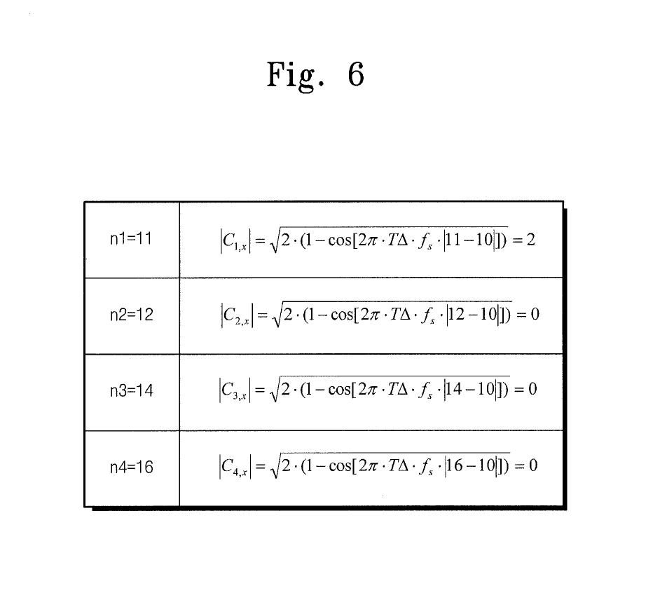

For instance, if the sampling rate is selected so that fₛ=100 MHz, n1, n2, n3 and n4 may be respectively determined as 11, 12, 14 and 16. And, in the case that the delay time TΔ is selected as 5 ns, exemplarily, the first and second interpolant functions S_{A}(f) and S_{B}(f) may be designed as 1 and −β¹⁰. That is, in Equations (13) and (14), nx is 10. Referring to Equation (14), a table of FIG. 6 is obtained.

FIG. 6 is a table exemplarily showing the value of the complex constant |C_{k,x}|. Referring to FIG. 6, in the case of n1=11, |C_{1,x}|=2. Accordingly, the first signal transitioned to the base band is recovered. On the contrary, |C_{2,x}|, |C_{3,x}| and |C_{4,x}| are 0. Therefore, the second to fourth signals transitioned to the base band may be eliminated.

Assume that some of the second to fourth signals R₂(f) to R_{R}(f) are interference signals, and not regular signals. And, by reconstructing of the signal process unit, the interference signals are eliminated, and signal in desired frequency band may be obtained.

According to the band pass sampling receiver and the method for operating the same according to the embodiment of the present invention, the first and second stream signals are generated by performing the sampling process to the signal which is a combined signal of the plurality of RF signals of different frequency bands with a time lag. And, by referencing the phase shift of the first and second stream signals, the sampling frequency and the frequency bands of the RF signals, the downward conversion, quantization, signal separation, signal detection and signal suppression are performed to the RF signals. Accordingly, the band pass sampling receiver which detects one RF signal and the method for operating the same are provided.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A band pass sampling receiver, comprising:
a sampling process unit configured to generate first and second stream signals sampled by applying a sampling rate having a time lag to a combined signal of first and second RF signals of different frequency bands; and
a signal process unit configured to perform an operation to a first interpolant function and the first stream signal and to a second interpolant function and the second stream signal, and separate the first and second RF signals by adding results of the two operations,
wherein the first and second interpolant functions are determined based on the time lag, the sampling rate and frequency bands of the first and second RF signals.

2. The band pass sampling receiver of claim 1, wherein the signal process unit detects one of the first and second RF signals.

3. The band pass sampling receiver of claim 1, wherein the signal process unit eliminates the first or second RF signals.

4. The band pass sampling receiver of claim 1, wherein the first and second interpolant functions are determined based on a phase shift of the first and second stream signals generated according to the time lag.

5. The band pass sampling receiver of claim 1, wherein the first and second interpolant functions are determined based on carrier frequencies of the frequency bands of the first and second RF signals.

6. The band pass sampling receiver of claim 5, wherein the carrier frequencies are center carrier frequencies of the frequency bands of the first and second RF signals.

7. The band pass sampling receiver of claim 5, wherein the carrier frequency of the frequency band of the first RF signal corresponds to a multiple of the sampling rate and a first constant, and the carrier frequency of the frequency band of the second RF signal corresponds to a multiple of the sampling rate and a second constant.

8. The band pass sampling receiver of claim 7, wherein the first and second interpolant functions are determined based on the first and second constants.

9. The band pass sampling receiver of claim 7, wherein the first and second interpolant functions are satisfied,
$${S}_{B} ( f ) = \{ \begin{matrix}{S}_{A} ( f ) \cdot - {e}^{j2π \cdot T Δ \cdot {f}_{s} \cdot nx} & - B < f < 0 \\ {S}_{A} ( f ) \cdot - {e}^{- j2π \cdot T Δ \cdot {f}_{s} \cdot nx} & 0 < f < B\end{matrix}$$
wherein SA(f), SB(f), TΔ, fs and B respectively correspond to the first interpolant function, the second interpolant function, the time lag, the sampling rate, and a bandwidth of the frequency bands of the first and second RF signals, and nx is determined based on the time lag, the sampling rate and the first and second constants.

10. The band pass sampling receiver of claim 9, wherein nx is configured to satisfy \sqrt{2·(1−cos [2π·TΔ·fₛ·|n2−nx|])}=0 and \sqrt{2·(1−cos [2π·TΔ·fₛ·|n1−nx|])}≠0, wherein n1 and n2 respectively correspond to the first and second constants.

11. The band pass sampling receiver of claim 1, wherein the signal process unit comprises:
a first interpolant unit configured to multiply the first interpolant function by the first stream signal and output a result of the multiplication;
a second interpolant unit configured to multiply the second interpolant function by the second stream signal and output a result of the multiplication; and
an adder configured to add outputs of the first and second interpolant units.

12. The band pass sampling receiver of claim 1, further comprising a clock generation unit configured to generate a first clock signal and a second clock signal delayed than the first clock signal, wherein the sampling process unit performs a sampling operation to the combined signal of the first and second RF signals by using the first and second clock signals.

13. The band pass sampling receiver of claim 1, wherein the sampling process unit generates the first and second stream signals by performing sampling and quantization operations to the combined signal of the first and second RF signals.

14. The band pass sampling receiver of claim 1, wherein the signal process unit separates the first and second RF signals down-converted to a base band.
